(19) United States
(12) Patent Application Publication
(10) Pub. No.: US 2017/0200171 A1
(43) Pub. Date: Jul. 13, 2017

(54) Workflow to Generate Metadata for New and Updated Products and Augment Short Message System Content

(71) Applicant: Dell Products L.P., Round Rock, TX (US)

(72) Inventors: Deepak Ravishankar, Bangalore (IN); Mainak Roy, Kolkata (IN); Rathi B., Bangalore (IN); Sharmad S. Naik, Bangalore (IN)

(73) Assignee: Dell Products L.P., Round Rock, TX (US)

(21) Appl. No.: 14/989,963

(22) Filed: Jan. 7, 2016

(51) Int. Cl. G06Q 30/02; G06Q 50/00; H04L 12/58

(52) U.S. Cl. CPC G06Q 30/0201; H04L 51/32; G06Q 50/01

(57) ABSTRACT

A system, method, and computer-readable medium are disclosed for performing an industry wide topic detection operation which automatically detects the topics of interest within a particular industry is disclosed. Such an industry wide topic detection operation enables an organization to potentially identify shortcomings of competitors of an organization as well as business opportunities for the organization. Data generated by the industry wide topic detection operation is also useful for an organization to identify customer centric solutions, to address industry wide issues which may not addressed by other organizations within the industry. Observing and proactively engaging on these hot issues before other organizations allows a particular organization to react before competing organizations. In various embodiments, topics of interest include one or more of hot topics, troubled topics and frequently discussed topics.

### BACKGROUND OF THE INVENTION

Field of the Invention

The present invention relates to information handling systems. More specifically, embodiments of the invention relate to a workflow to generate metadata for new and updated products and to augment short message system content.

Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The widespread availability of such information handling systems has been instrumental in the adoption of social media into the mainstream of everyday life. Social media commonly refers to the use of web-based technologies for the creation and exchange of user-generated content for social interaction. Twitter is an example of such a social media platform where users from across the world come together to engage in live, public or professional conversations. With a social media platform, short message identification is often accomplished via a short message tag identifier. In certain social media platforms, this short message tag identification is accomplished using metadata such as tag data (e.g., identified as #tag (pronounced “hashtag”)). Organizations can participate in these conversations by connecting with users that have diverse backgrounds and interests. Social media platforms provide an effective means of sharing thoughts and views. It is known for organizations to have multiple short message identifiers (e.g., handles) for different purposes where certain identifiers are directed to specific audiences. It is also known that a short message identifier associated with an influencer can increase network traffic and data for a specific group or audience. This network traffic and data can be amplified by individuals associated with the organization (e.g., employees), channel partners as well as by customers. This amplification can occur via a republication of the short message (e.g., a “re-tweet”) as well as by identifying the short message as a favorite. It is also possible that certain users that access the short message do not amplify the content, but rather use the short message to access further information regarding the short message (e.g., by accessing content identified within the short message).

It is known for an organization to have an active presence on a plurality of social media platforms across a plurality of channels, a plurality of partner channels and a plurality of influencers. Within certain social media platforms, customer generated data can identify issues for a product. Often, when an issue is identified, other customers may attempt to contact the organization to obtain additional information regarding the issue as well as any relevant solutions. Additionally, customers may attempt to contact competitors of an organization to obtain additional information regarding the issue as well as any relevant solutions. Additionally, customer generated data may be generated from different geographic locations. With certain issues, the topics may start trending and become “hot” topics across an industry. It would be desirable to be able to identify trending topics which relate to a particular organization or industry. Doing so can enable an organization to proactively address an issue.

### SUMMARY OF THE INVENTION

A system, method, and computer-readable medium are disclosed for performing an industry wide topic detection operation which automatically detects the topics of interest within a particular industry is disclosed. Such an industry wide topic detection operation enables an organization to potentially identify shortcomings of competitors of an organization as well as business opportunities for the organization. Data generated by the industry wide topic detection operation is also useful for an organization to identify customer centric solutions, to address industry wide issues which may not addressed by other organizations within the industry. Observing and proactively engaging on these hot issues before other organizations allows a particular organization to react before competing organizations. In various embodiments, topics of interest include one or more of hot topics, troubled topics and frequently discussed topics. In various embodiments, the industry wide topic detection operation further identifies social media content, relevant short message identifiers as well as social signals via which the topics of interest can then be amplified. For the purposes of this disclosure social signals may be defined as the inbound and out bound links from a single source to multiple platforms or from different platforms to a single source. Customers can access the information in several ways and that's how social signals are generated. In various embodiments, the industry wide topic detection operation provides a global map of the topics of interest. In various embodiments, the industry wide topic detection operation is based on real-time data. In various embodiments, the industry wide topic detection operation provides benchmark information with respect to other organizations within a particular industry. In various embodiments, the social media platforms include the Enterprise social media platform and the Twitter social media platform. In various embodiments, the social media platform include message tag identification via tag data metadata.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of delivery of a short message.

FIG. 3 shows a block diagram of a topic detection environment.

FIG. 4 shows a block diagram of a work flow of a topic detection operation within a topic detection environment.

FIG. 5 shows a block diagram of a tag identification collection operation.

FIG. 6 shows a flow chart of an operation suing trending tag identifiers to identify issues of interest.

FIG. 7 shows a flow chart of an overlapping issue detection operation.

FIG. 8 shows a flow chart of a report generation operation.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

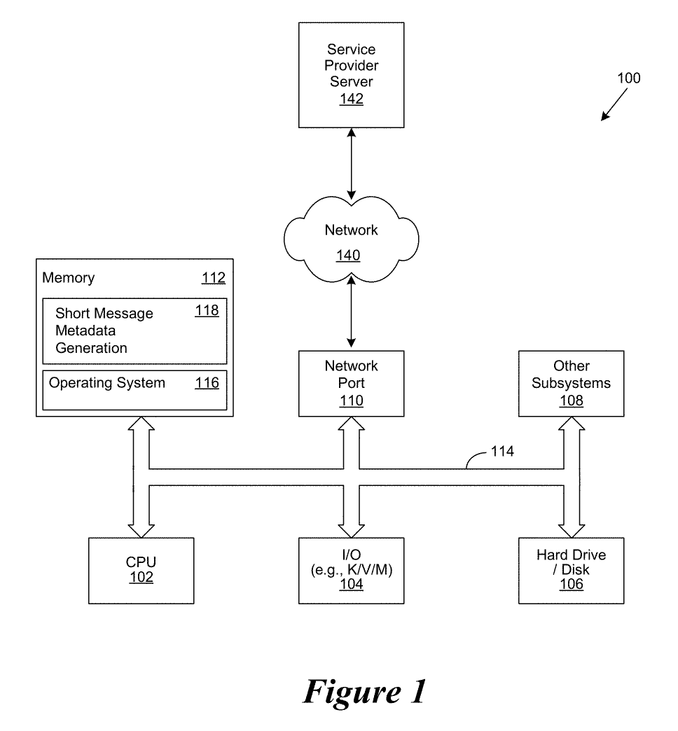

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise an industry wide topic detection module 118.

The industry wide topic detection module 118 performs an industry wide topic detection operation. In various embodiments, the industry wide topic detection operation automatically detects the topics of interest within a particular industry. Such an industry wide topic detection operation enables an organization to potentially identify shortcomings of competitors of an organization as well as business opportunities for the organization. Data generated by the industry wide topic detection operation is also useful for an organization to identify customer centric solutions, to address industry wide issues which may not addressed by other organizations within the industry. Observing and proactively engaging on these hot issues before other organizations allows a particular organization to react before competing organizations. In various embodiments, topics of interest include one or more of hot topics, troubled topics and frequently discussed topics. In various embodiments, the industry wide topic detection operation further identifies social media content, relevant short message identifiers as well as social signals via which the topics of interest can then be amplified. In various embodiments, the industry wide topic detection operation provides a global map of the topics of interest. In various embodiments, the industry wide topic detection operation is based on real-time data. In various embodiments, the industry wide topic detection operation provides benchmark information with respect to other organizations within a particular industry. In various embodiments, the social media platforms include the Enterprise social media platform and the Twitter social media platform. In various embodiments, the social media platform includes message tag identification via tag data metadata. For the purposes of this disclosure, industry may be defined as the aggregate of manufacturing or technically productive enterprises in a particular field, often named after its principal product (e.g., the computer industry, the automobile industry, the steel industry). For the purposes of this disclosure, industry-wide may be defined as affecting substantially all of an industry (i.e., more than 75% of an industry).

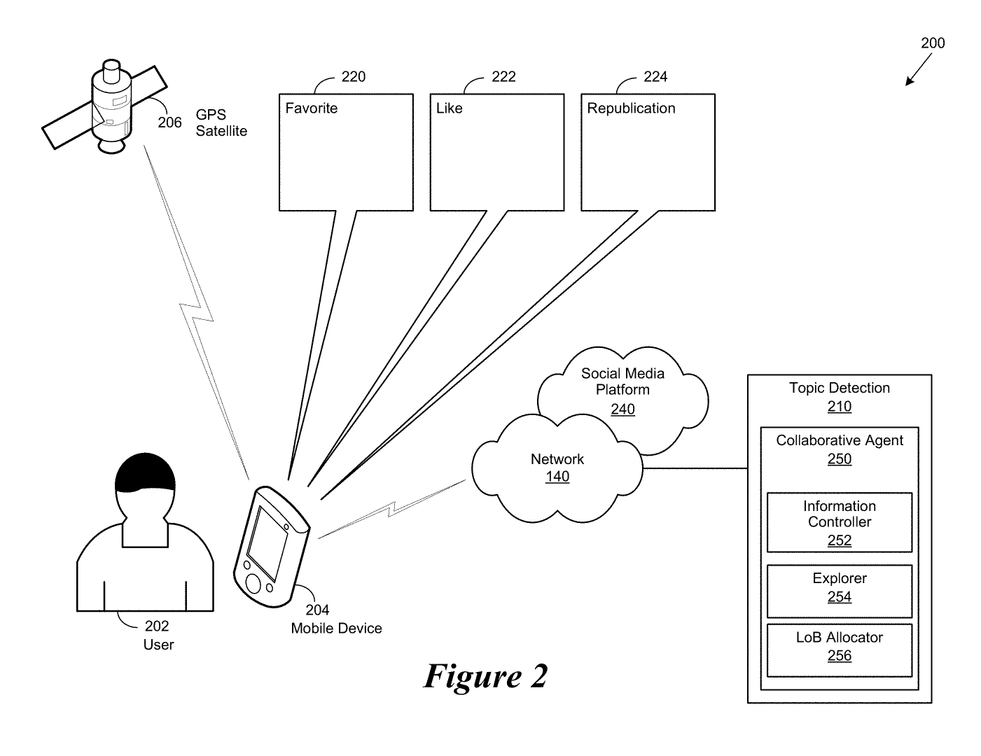

FIG. 2 shows a simplified block diagram of the delivery of a short message implemented in accordance with an embodiment of the invention. As used herein, a short message broadly refers to a short message associated with a social media platform. In this and other embodiments, these short messages may be delivered to a mobile device 204 being used by a user 202.

As used herein, a mobile device 204 refers to wireless devices such as mobile telephones, smart phones, personal digital assistants (PDAs), tablet computers, handheld or laptop computers, and similar devices that have telecommunications capabilities. In various embodiments, the mobile device 204 is used to exchange information between a user 202 and a short message tool 210, described in greater detail herein through the use of a network 140. In certain embodiments, the network 140 is likewise used by the mobile device 204 to exchange information between the user 202 and one or more social media platforms 240.

In various embodiments, the network 140 may be a public network, such as the Internet, a physical private network, a virtual private network (VPN), a wireless network, or any combination thereof. In certain embodiments, the wireless network may be a personal area network (PAN), based on technologies such as Bluetooth or Ultra Wideband (UWB). In various embodiments, the wireless network may include a wireless local area network (WLAN), based on variations of the IEEE 802.11 specification, often referred to as WiFi. In certain embodiments, the wireless network may include a wireless wide area network (WWAN) based on an industry standard including two and a half generation (2.5G) wireless technologies such as global system for mobile communications (GPRS) and enhanced data rates for GSM evolution (EDGE). In various embodiments, the wireless network may include WWANs based on existing third generation (3G) wireless technologies including universal mobile telecommunications system (UMTS) and wideband code division multiple access (W-CDMA).

Other embodiments may include the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies. Skilled practitioners of the art will realize that many such embodiments are possible and the foregoing is not intended to limit the spirit, scope or intent of the invention.

In various embodiments, the short message may be delivered in the form of a Short Message Service (SMS) message, a Multimedia Messaging Service (MIMS) message, or a Tweet® message, provided by Twitter, Inc. of San Francisco, Calif. Skilled practitioners of the art will be familiar with SMS messages, which are a text messaging service component of telephone, Web, or mobile communication systems. SMS messages are limited to a total of 160 seven-bit characters and use a stateless communications protocol, meaning every SMS message is considered independent of other messages. In certain embodiments, SMS messages may be concatenated to provide larger amounts of content within the cognitive short message. While SMS is typically implemented for person-to-person (P2P) messaging, it may also be implemented in certain embodiments for application-to-person (A2P) messaging. As an example, the short message tool 210 may be implemented to deliver a short message to a user's 202 mobile device 204.

Those of skill in the art will likewise be familiar with MMS messages, which provide a way to send messages that include multimedia content to and from mobile devices 204. Currently, the most popular use of MMS is to send photographs from camera-equipped mobile devices 204. However, MMS may implemented in various embodiments to deliver news and entertainment content as part of a cognitive short message. In certain embodiments, MMS may likewise be implemented to deliver scannable coupon codes, product images, audio, videos and other information as part of a cognitive short message.

Twitter, Inc. will likewise be familiar to skilled practitioners of the art as a social media service that allow users to send and receive short, 140 character messages, known as Tweets®. Currently, registered users of Twitter can read and post Tweets®, but unregistered users are only allowed to receive them. In various embodiments, Twitter can be accessed through a website interface, SMS, or an application implemented on a mobile device 204. In these and other embodiments, Twitter users may subscribe to Tweets® from other users, which is known as “following.” In certain embodiments, Tweets® may be implemented to accommodate multimedia content.

Short message operations are initiated by first selecting a target user 202 and then performing ongoing monitoring operations to monitor their social media interactions, their physical location, and the current date and time. If a social media interaction 220 by the target user 202 is detected, then data associated with the social media interaction is captured. For example, the social media interaction data may include a user post 220 to a social media platform 240 (e.g., a tweet). The user post may take the form of a favorite indication within a short message 220, a like indication within a short message 222 or a republication (also referred to as a forwarding) short message 224 (e.g., a re-tweet). Additionally, in certain embodiments, the location of the user 202 may be determined through the use of Geographical Positioning System (GPS) satellite 206 data acquired by the user's mobile device 204. Some or all of the information gathered when performing short message operations may be used when performing a short message tag identification operation. For example, in certain embodiments, trending information may be derived from information obtained from the short message operations.

In various embodiments, the industry wide topic detection system 210 includes some or all of the functionality of the industry wide topic detection module 118. In certain embodiments, the industry wide topic detection system 210 includes a collaborative agent 250. The collaborative agent 250 further includes one or more of an information controller module 252, an explorer module 254 and a line of business allocator module 256.

In various embodiments, the collaborative agent 250 is associated with and executes on a server type information handling system such as information handling system 100. The server type information handling system may be internal to a particular company or may be associated in some way with a particular company such as by executing on a virtual machine which is remotely located but is controlled by the company. The collaborative agent 250 communicates with and receives information from a social media platform such as the Twitter social media platform. In certain embodiments, the collaborative agent 250 accesses the social media platform via a predefined set of application program interfaces (APIs) such as the streaming APIs available from certain social media platforms.

With certain social media platforms, the streaming APIs provide access to some or all of short message public streams, short message user streams and short message site streams. While these streams are intended for servers which connect to the social media platform on behalf of many users, the collaborative agent 250 stands in for a user in the present invention and becomes the user of the data. The collaborative agent 250 also has the control to monitor both inbound and outbound data streams and to fetch different metadata from the inbound and outbound data streams of the social media platforms.

When the collaborative agent 250 collects the information from the various streams, the information from the various streams is stored within a database which contains metadata for products that are associated with the company, e.g., products within a particular product portfolio. Whereas the line of business specific database is controlled by the company to modify, enter, add and define data for a product as well as a line of business.

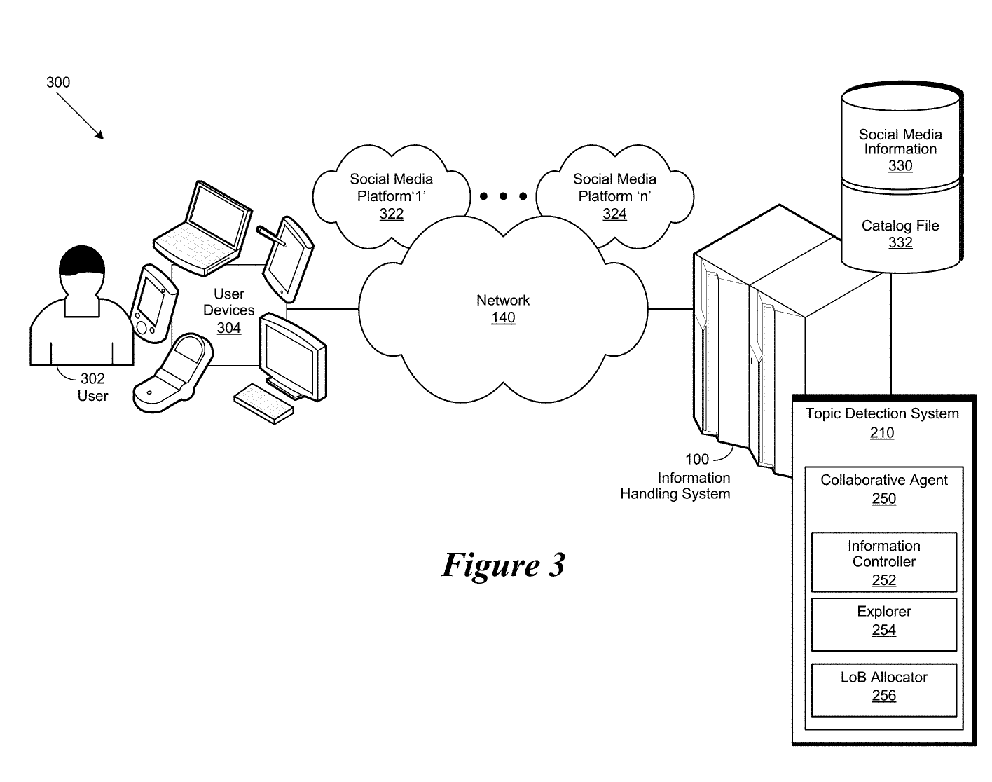

FIG. 3 is a simplified block diagram of a topic detection environment 300 implemented in accordance with an embodiment of the invention. In various embodiments, a user 302 may post information to a social media platform ‘a’ 322 through ‘n’ 324, which in turn may become a trending post. In various embodiments, the post information is based upon identified trending information and is identified via a suggested tag identifier. In these and other embodiments, the user 302 may use a user device 304 to post the information to a social media platform ‘a’ 322 through ‘n’ 324.

As used herein, a user device 304 refers to an information handling system such as a personal computer, a laptop computer, a tablet computer, a personal digital assistant (PDA), a smart phone, a mobile telephone, or other device that is capable of communicating and processing data. In various embodiments, the user device 304 is used to exchange information between the user 302 and a social media platform ‘a’ 322 through ‘n’ 324 through the use of a network 140. In certain embodiments, the network 140 may be a public network, such as the Internet, a physical private network, a wireless network, a virtual private network (VPN), or any combination thereof. Skilled practitioners of the art will recognize that many such embodiments are possible and the foregoing is not intended to limit the spirit, scope or intent of the invention.

In certain embodiments, an industry wide topic detection system 210 is implemented on an information handling system 100 to perform an industry wide topic detection operation to a social media platform ‘a’ 322 through ‘n’ 324. In these various embodiments, the network 140 is used by the industry wide topic detection system 210 to monitor the social media platforms ‘1’ 322 through ‘n’ 324 for tag identification information for a particular industry in which the organization is part. In certain embodiments, this information includes as well as trending tag identification data for the organization as well as competitors of the organization.

The industry wide topic detection system 210 collates trending short message identification information (e.g., #tags) from one or more social media platforms (e.g., Twitter) for a particular organization, categorizes the trending short message identification information and stores the short message identification information along with the suggestive short message identification information which are proposed by the organization. The industry wide topic detection system 210 also collects and considers short message identification information which are generated by other organizations within a particular industry (e.g., by competitors of the organization). The industry wide topic detection system 210 also collects and considers short message identification information which are generated by customers within the particular industry whether they be customers of the organization or customers of competitors of the organization. Based upon the collected and collated short message identification information, the industry wide topic detection system 210 generates a guidance map for the organization for its entire product portfolio.

As the collaborative agent 250 collects information from the social media platforms 322, 324, the collaborative agent stores this information to the social media information repository 330. The information stored to the social media information repository includes any trends and relevant tags relating to a product portfolio of the organization. In certain embodiments, this repository may include a line of business specific repository. In certain embodiments, the collaborative agent 250 interacts with different LOB specific filters to categorize the collected information (including in certain embodiments any retrieved #tags). In certain embodiments, the repository includes a catalog file where the information is stored. In various embodiments, the collaborative agent 250 performs the information collection operation on a regular basis (e.g., every day). When performing the information collection operation whenever there is new or updated information (e.g., a new #tag), the repository is updated accordingly. Also, the collaborative agent 250 provides an option to the organization to edit either the lines of business or the product lines such as by add new lines of business or updating product associated with a particular line of business. In certain embodiments, the repository includes a line of business specific repository 330 to which the line of business specific information to stored. Thus, the organization can have a control on which information is stored with respect to which line of business. For example, a certain product may need to move to a different LOB due to a business requirement. Additionally, the organization can add new organization specific identifiers (e.g., #tags) to a product/LOB specific catalog file.

One or more user devices 304 provide interface to the social media platforms 322, 324. The user devices 304 fetch the catalog file 332 periodically to access to any metadata of interest. As an administrative user of such user devices 304, the user 302 can schedule this process to occur on a regular basis. Based on the configuration of the user device 304, it will access and collect the collaborative agent generated catalog file 332. The user 302 can use the information garnered from the catalog file 332 when posting to a social media platform and/or to easily join any identified ongoing trends.

In operation, the information controller module 252 provides an information gathering operation for the collaborative agent 250. More specifically, the information controller module 252 interacts with the various social media platforms, identifies any trending topics for each of the social media platforms and retrieves any tag identification information (e.g., tag metadata such as #tags) which are being used to describe the identified trending topics. The information controller module 252 includes the intelligence to identify and follow primary identifiers (i.e., company owned identifiers for competitors of the organization) as well as secondary identifiers (i.e., identifiers associated with followers of the primary identifiers). By identifying and following the primary and secondary identifiers, the information controller module can gather information relating to the industry of interest including information relating to competitors of the organization.

After the tag identification information is retrieved by the information controller module 252, the tag identification information is analyzed using predetermined keywords and tag identification information. In various embodiments, the predetermined keywords and tag identification information relate to specific lines of business and/or specific products. In various embodiments, the predetermined keywords and tag identification information are stored within a line of business specific repository and are used to provide a line of business specific filter for determining where to store the retrieved tag identification information.

While retrieving the tag identification information, the information controller module 252 prioritizes any issues that are contained within the content associated with the tag identification information. The information controller module 252 also identifies any overlapping issues (i.e., issues that overlap various lines of business and/or various products). The issues may be identified based upon topics that are being discussed by multiple customers and/or multiple channels for different companies within the industry. The information controller module 252 may segregate and prioritize various topics of interest based on a number of occurrences of particular topics.

The information controller module 252 also generates a ranked list of discussed topics relating to the industry of the organization. In various embodiments, this ranked list may be based on merits associated with the topics (e.g., where many customers are discussing a particular topic, this topic is identified as having more merit (i.e., importance)).

The explorer module 254 includes the intelligence to analyze the data collected by the information controller module 252. In various embodiments, the explorer module 254 receives the ranked list from the information controller module 252. When reviewing the data collected by the information controller module 252, the explorer module analyzes the data to determine whether the data relates to any topics of interest. In certain embodiments, the topics of interest include topics relating to comparable products of the organization in any of the lines of business of the organization. If the data relates to a topic of interest, then the explorer module 254 proceeds with further analysis. In various embodiments, the further analysis includes matching the collected data to any trending tag identifiers and/or any generic keywords to identify a product of the organization to which the data relates. If the topic of interest overlaps a plurality of products, then the explorer module checks for the data from the plurality of products and stores the information about the issue in separate locations for each product. In certain embodiments, a plurality of products may be necessary to address a particular issue. If the organization does not have any product offering corresponding to the topic of interest, the explorer module 254 stores the information along with a topic of interest entry.

When the explorer module 254 identifies a product of the organization relating to the topic of interest, the explorer module 254 searches information relating to the product to understand the organization's position regarding the issue. For example, the information relating to the product may be a “known issues” repository associated with the product. In certain situations, the organization may have some limitations regarding a particular topic of interest. In this case, the operation does not proceed further.

In certain embodiments, the explorer module 254 may identify positive solutions to an industry oriented issues. If this is the case, then the explorer module may perform one or more of a plurality of actions. For example, in a case where a solution to the topic of interest is not readily available, the explorer module 254 may generate a customized report for any individuals responsible for the product within a particular line of business. For example, these individuals may be subject matter experts (SMEs). By providing this report, the SME can directly review the topic of interest and identify a solution to the issue. This information can also be used as an input and/or supporting reference for further product improvement.

In certain embodiments, the organization might have a positive response or product to address one or a plurality of topics of interest. If this is the case, then the explorer module 254 can identify the positive response and associate the response with the topic of interest to allow the organization to promote the response via any of a plurality of associated channels. In certain embodiments, the explorer module 254 can generate competitive benchmark studies (CBS) report using a plurality of parameters of a product that is related in some way to the topic of interest. In various embodiments, the parameters can include one or more of availability of the product, searchability of the documentation, usability aspects of the product or any other parameter that is associated with the product.

The line of business (LOB) allocator module 256 provides an interactive function to the collaborative agent 250. For example, the LOB allocator module 256 provides a user 302 with information regarding which product is associated with a topic of interest (e.g., can answer or address an issue raised in a topic of interest). The LOB allocator module 256 also analyzes further details from an LOB based filter to identify any associated channels and/or partner channels related to that product and line of business. The LOB allocator module 256 also provides suggestions regarding details of the customers (of either the organization or competitors of the organization) who are using a similar kind of product. The user 302 may then determine how they wish to use this information.

The LOB allocator module 256 also updates the catalog files of any products relating to the topic of interest which have been downloaded onto the user devices 304. The LOB allocator module 256 can also initiate distribution of the topic of interest as well as any proposed solutions. In certain embodiments this distribution is via a browser executing on the user device 304.

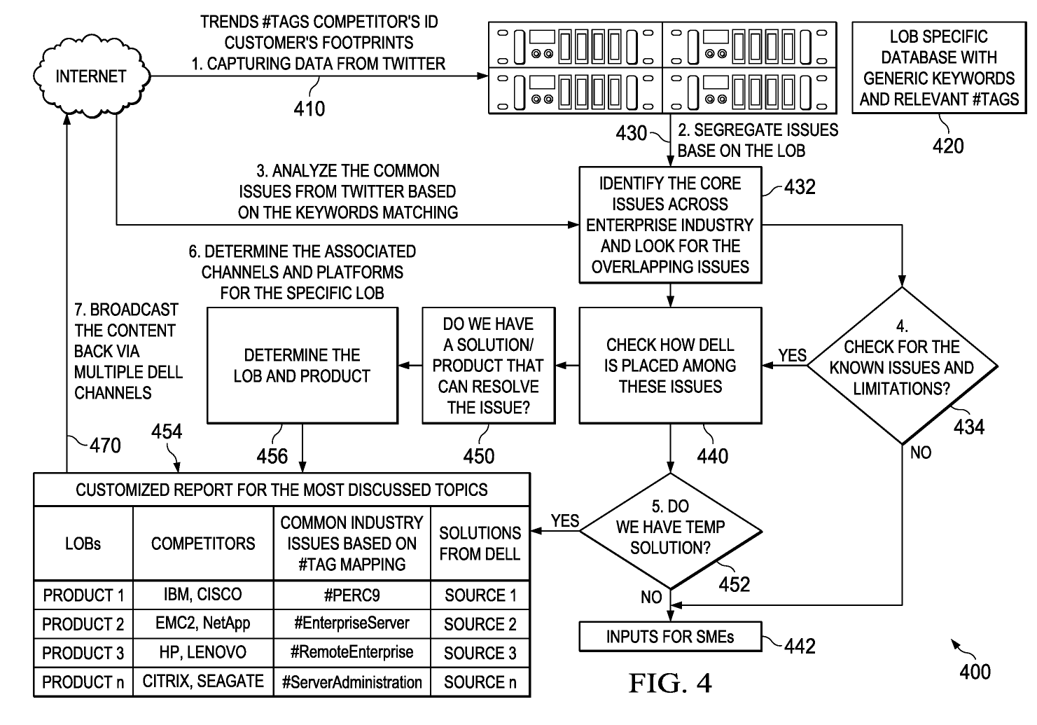

Referring to FIG. 4, a block diagram of a work flow of a topic detection operation within a topic detection environment 400 is shown. More specifically, the work flow begins at step 410 by capturing data from a social media platform such as a Twitter social media platform. The captured data includes one or more of identified trends, short message tag identification data (e.g., #tags), identifiers of competitors, and/or customers footprints. For the purposes of this disclosure, customer footprints may be defined as a map generated by tracing substantially all relevant information for which a customer are searching. For example, if customer is searching for a particular server and they are discussing about the same over twitter, the operation also determines whether the customer is discussing servers from any other company or not. Such a determination enables the operation to increase the information obtained regarding the customer. This captured data is stored within a repository such as a line of business specific database. The data is stored along with generic keywords and relevant short message tag identification data. Next, at step 420, any identified issues are segregated, such as by line of business of the organization. Next at step 430, the workflow analyzes the data for common issues being posted to the social media platform based upon keyword matching. Next, at step 432, the work flow identifies core issues across a particular industry and identifies any overlapping issues. Next, at step 434, the work flow determines whether there are any known internal organizational issues and/or limitations relating to the identified issues. If so, then at step 440, the work flow determines how the organization is placed among the issues. If not, then at step 442, the work flow generates inputs for any SMEs of the organization to deal with the identified issue.

After the work flow determines how the organization is placed among the issues at step 440, the work flow determines whether the organization has a solution and/or product that can resolve the issue at step 450 and also determines whether the organization has a temporary solution to the issue at step 452. If the organization does not have a temporary solution, then work flow proceeds to step 442 to generate inputs for any SMEs of the organization to deal with the identified issue. If the organization does have a temporary solution, then the workflow generates a report 454 which includes information regarding the solution. After the work flow determines whether the organization has a solution and/or product that can resolve the issue at step 450, the work flow identifies any associated channels and platforms that relate to the identified issue at step 456. In certain embodiments, this step includes identifying whether particular lines of business and/or products of the company that are associated with the solution. Next, the work flow generates a report which includes information regarding the solution. Next at step 470, the work flow enables a user to use the information from the report to broadcast content (e.g., a solution that is available from the organization to the identified issue) via the social media platform. In certain embodiments, the broadcast may be across multiple channels (e.g., multiple short message identifiers) of the organization.

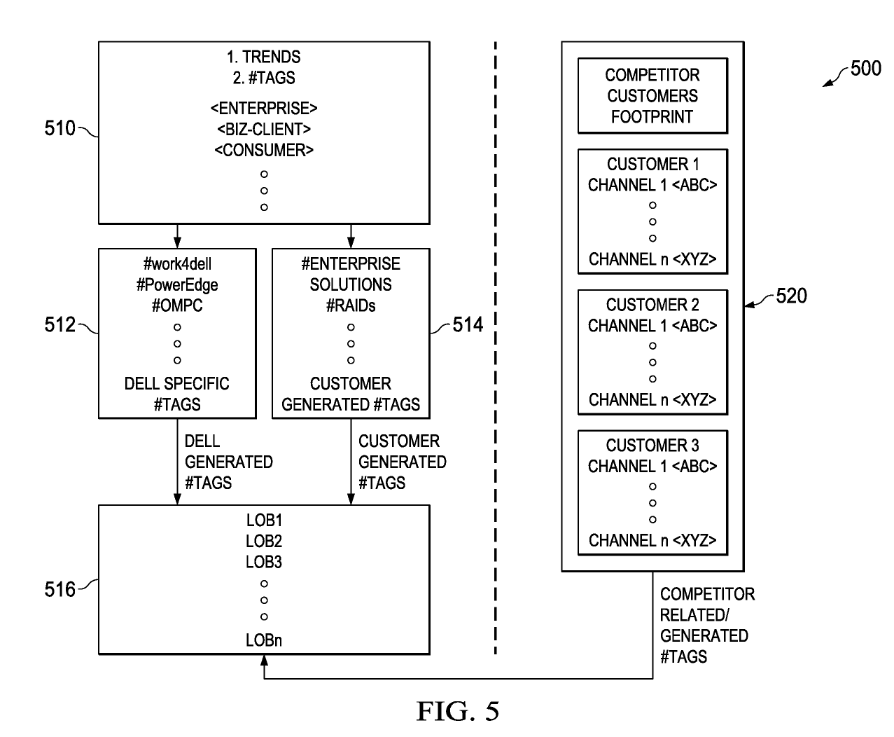

Referring to FIG. 5, a block diagram of a tag identification collection operation 500 is shown. More specifically, trend data and short message identification data associated with the organization are collected at step 510. The trend data and short message data associated with the organization are then separated based upon organization specific short message identification data 512 and customer specific short message identification data 514. In certain embodiments, this trend data and short message data are then sorted by line of business of the organization and stored accordingly at step 516.

The tag identification collection operation 500 also performs a competitor customer footprint operation 520 where customers (Customer 1, Customer 2, Customer 3) of one or more competitors of the organization are identified. When these customers are identified, channels 522 associated with each customer are also identified (Channel 1 <abc>, Channel n<xyz>). Using this customer information and channel information, competitor related trend data as well as competitor related short message identification data are collected. In certain embodiments, this competitor related trend data and competitor related short message data are then sorted by line of business of the organization and stored accordingly at step 516.

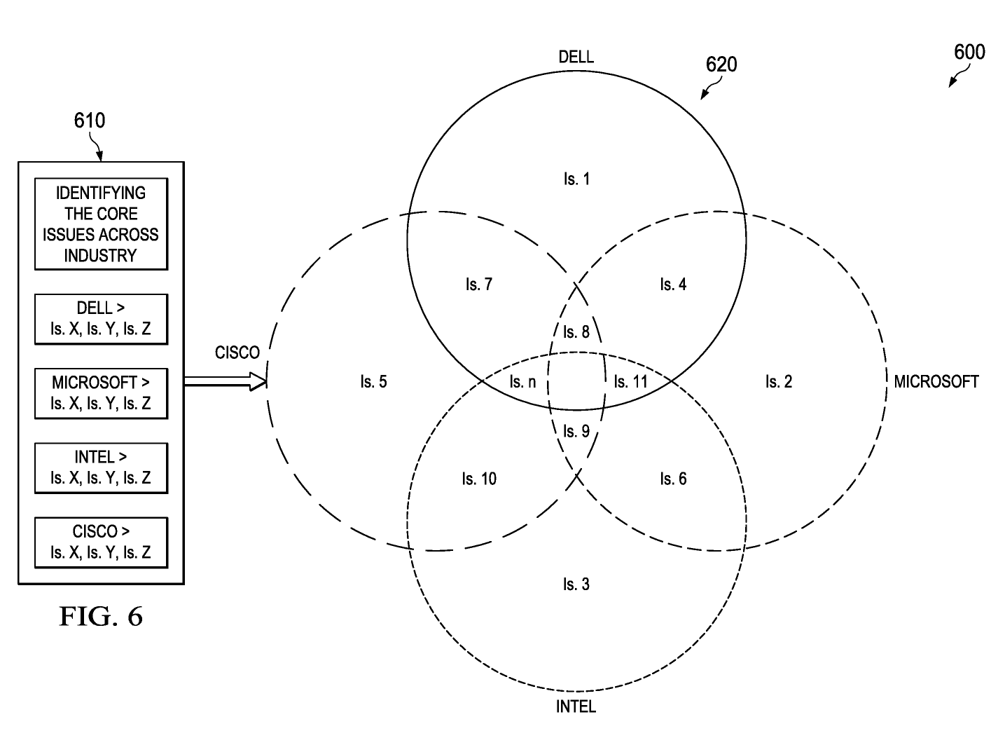

Referring to FIG. 6, a flow chart of an operation 600 using trending tag identifiers to identify issues of interest across an industry is shown. More specifically, the operation 600 starts by performing an industry wide issue gathering operation 610. During this issue gathering operation, issues are segregated by organizations within a particular industry. For example, a first organization may have an associated plurality issues (Is 1X, Is 1Y, Is 1Z). Another organization may have an associated plurality of issues (Is 2X, Is 2Y, Is 2Z). Another organization may have an associated plurality of issues (Is 3X, Is 3Y, Is 3Z). Another organization may have an associated plurality of issues (Is 4X, Is 4Y, Is 4Z). Next, at step 620, overlapping issues are identified. Identifying overlapping issues enables the operation to determine whether a certain issue may be prevalent in multiple companies. For example, Issue1 may be applicable for company1 as well as company2. Whereas, a combination of issue1 and issue2 is applicable for company3 and so on. In certain embodiments, set theory may be applied to identify the overlapping issues.

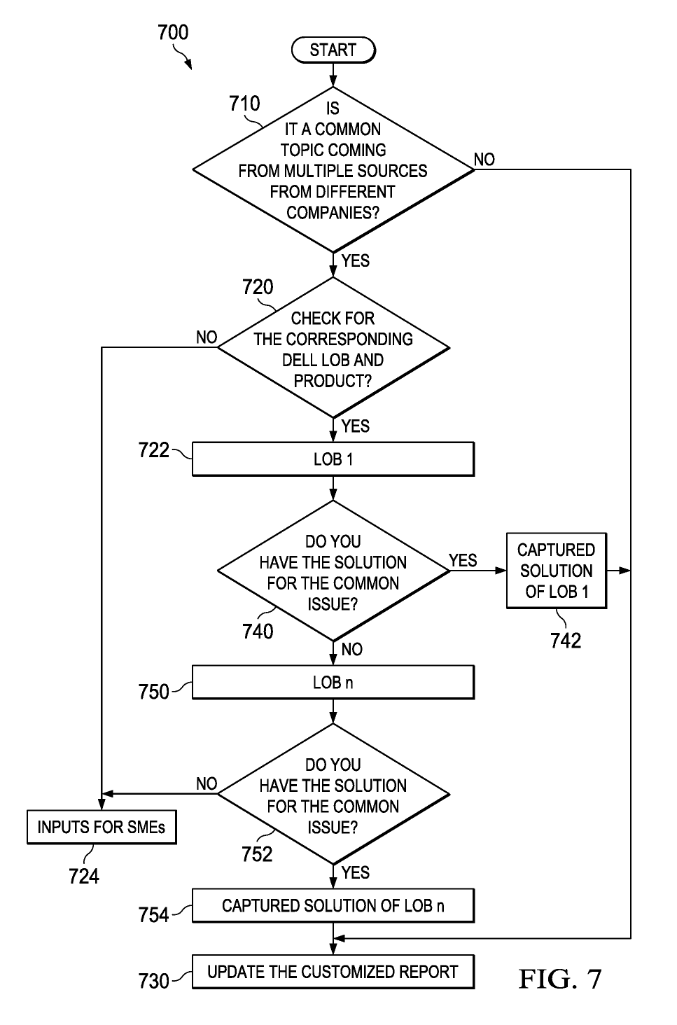

Referring to FIG. 7, a flow chart of an overlapping topic detection operation 700 is shown. More specifically, the operation 700 begins at step 710 with a determination of whether a common topic (i.e., issue) is being generated by multiple sources from multiple companies. If so, then the operation proceeds to step 720 where the operation 700 determines whether the topic has an associated line of business and/or product within the organization. If so, then the operation proceeds to step 722 with associating the topic with the line of business. If not, then the topic is provided as an input for an SME of the organization at step 724. If the common topic is not being generated by multiple sources from multiple companies, then the operation 700 updates a report relating to the topic at step 730. After the topic is associated with a line of business at step 722, the operation proceeds to determining whether the organization has a solution to the topic at step 740. If so, then the solution for the line of business associated with the topic is captured at step 742 and then used to update the report at step 730.

If the organization does not have a solution to the topic, then the topic is forwarded to the next line of business with which the topic is associated at step 750. After the topic is associated with the next line of business at step 750, the operation proceeds to determining whether the line of business organization has a solution to the topic at step 752. If so, then the solution for the line of business associated with the topic is captured at step 754 and then used to update the report at step 730. If not, then the topic is provided as an input for an SME of the organization at step 724.

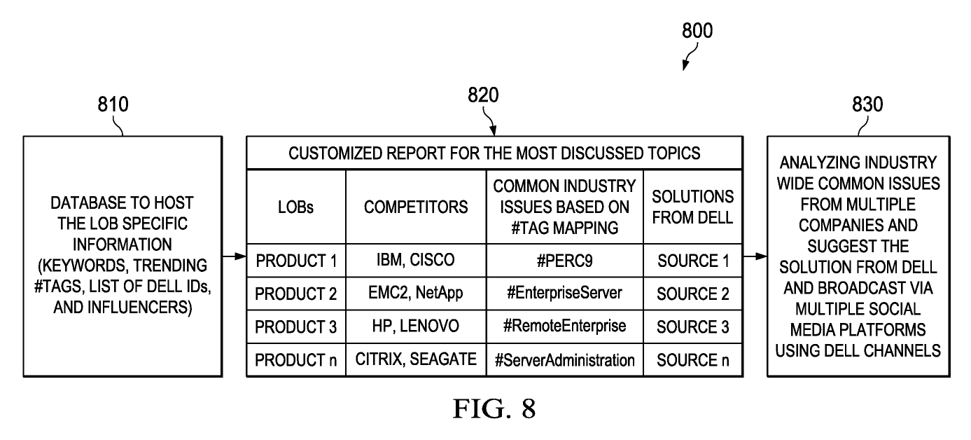

Referring to FIG. 8, a flow chart of a report generation operation 800 is shown. More specifically, the operation 800 begins by access a database which is storing the line of business specific information relating to the common topic at step 810. In various embodiments, this line of business specific information includes one or more of keywords, trending short message identifiers, a list of organization identifiers associated with the keywords and influences associated with the keywords. Using this information a customized report may be generated at step 820. In certain embodiments, this customized report includes information relating to associated lines of business, competitors associated with the topic of interest, a mapping of short message identifiers to the issue of interest and a link to solutions that can be provided by the organization. The report can be used when analyzing industry wide common issues for multiple companies at step 830. The report can also be sued to suggest a solution from the organization. This solution may be broadcast via multiple social media platforms.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing an industry-wide topic identification operation, comprising:
identifying a plurality of social media identifiers, the plurality of social media identifiers being associated with a respective plurality of organizations within an industry
monitoring a social media platform for a post associated with one of the plurality of social media identifiers, the monitoring being performed by a monitoring organization, the monitoring organization being within the industry;
determining whether the post relates to a topic of interest; and,
determining whether the monitoring organization has a solution to the topic of interest.

2. The method of claim 1, wherein:
the topic of interest include at least one of hot topics, troubled topics and frequently discussed topics.

3. The method of claim 1, further comprising:
identifying social media content within the post;
identifying short message identifiers associated with the post.

4. The method of claim 1, further comprising:
identifying influencers associated with the topic of interest; and,
engaging the influences via company generated short messages.

5. The method of claim 1, further comprising:
providing benchmark information with respect to other plurality of organizations within the industry.

6. The method of claim 1, wherein:
the social media identifier includes message tag identification via tag data metadata.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
identifying a plurality of social media identifiers, the plurality of social media identifiers being associated with a respective plurality of organizations within an industry
monitoring a social media platform for a post associated with one of the plurality of social media identifiers, the monitoring being performed by a monitoring organization, the monitoring organization being within the industry;
determining whether the post relates to a topic of interest; and,
determining whether the monitoring organization has a solution to the topic of interest.

8. The system of claim 7, wherein:
the topic of interest include at least one of hot topics, troubled topics and frequently discussed topics.

9. The system of claim 7, wherein the instruction executable by the processor are further configured for:
identifying social media content within the post;
identifying short message identifiers associated with the post.

10. The system of claim 7, wherein the instruction executable by the processor are further configured for:
identifying influencers associated with the topic of interest; and,
engaging the influences via company generated short messages.

11. The system of claim 7, wherein the instruction executable by the processor are further configured for:
providing benchmark information with respect to other plurality of organizations within the industry.

12. The system of claim 7, wherein:
the social media identifier includes message tag identification via tag data metadata.

13. A non-transitory, computer-readable storage medium embodying computer program code, the computer program code comprising computer executable instructions configured for:
identifying a plurality of social media identifiers, the plurality of social media identifiers being associated with a respective plurality of organizations within an industry;
monitoring a social media platform for a post associated with one of the plurality of social media identifiers, the monitoring being performed by a monitoring organization, the monitoring organization being within the industry;
determining whether the post relates to a topic of interest; and,
determining whether the monitoring organization has a solution to the topic of interest.

14. The non-transitory, computer-readable storage medium of claim 13, wherein:
the topic of interest include at least one of hot topics, troubled topics and frequently discussed topics.

15. The non-transitory, computer-readable storage medium of claim 13, wherein the computer executable instructions are further configured for:
identifying social media content within the post;
identifying short message identifiers associated with the post.

16. The non-transitory, computer-readable storage medium of claim 13, wherein the computer executable instructions are further configured for:
identifying influencers associated with the topic of interest; and,
engaging the influences via company generated short messages.

17. The non-transitory, computer-readable storage medium of claim 13, wherein the computer executable instructions are further configured for:
providing benchmark information with respect to other plurality of organizations within the industry.

18. The non-transitory, computer-readable storage medium of claim 13, wherein:
the social media identifier includes message tag identification via tag data metadata.
